(19) United States
(12) Patent Application Publication
(10) Pub. No.: US 2014/0126513 A1
(43) Pub. Date: May 8, 2014

(54) METHOD OF PROVIDING CONTROL INFORMATION FOR USER EQUIPMENT

(71) Applicant: NEC CORPORATION, Tokyo (JP)

(72) Inventors: Phong Nguyen, Victoria (AU); Satha Sathananthan, Victoria (AU); Kevin Lin, Victoria (AU)

(21) Appl. No.: 14/129,079

(22) PCT Filed: Feb. 18, 2013
(86) PCT No.: PCT/JP2013/054642

§ 371 Date: Dec. 23, 2013

(30) Foreign Application Priority Data
Mar. 14, 2012 (JP) 2012901017

(51) Int. Cl. H04L 5/00; H04W 88/02; H04W 88/08; H04W 72/04

(52) U.S. Cl. CPC H04L 5/0053; H04W 72/042; H04W 88/02; H04W 88/08
USPC 370/329

(57) ABSTRACT

A method of providing control information for user equipments (UEs) in communication with a base station over a wireless communication system includes: mapping at least one enhanced-physical downlink control channel (E-PDCCH) on at least one allocated pair of physical resource blocks (PRBs) according to an enhanced-control channel element (ECCE) structure including a variable number of resource element groups (REGs); and varying the number of REGs in an E-CCE structure.

### TECHNICAL FIELD

The present invention relates to a method of providing control information for User Equipment (UEs) in data communication, and in particular to using enhanced physical downlink control channels (E-PDCCH) for configuring the UEs.

### BACKGROUND ART

In existing Long Temi Evolution (LTE) wireless communication systems, such as LTE Release 8, 9 and 10, an eNodeB in the LTE system determines which User Equipment (UE) in the system should be granted uplink resources for data transmission and which UE should be scheduled for data reception in the downlink, and then provides suitable control information for the UEs accordingly. In one example, the eNodeB determines an amount of control channel resources of a Physical Downlink Control Channel (PDCCH) that is required and supported for the UEs comprising this control information.

### SUMMARY OF INVENTION

### Technical Problem

There current exists a need to optimise the use of control channel resources to improve system capabilities.

### Solution to Problem

One aspect of the invention provides a method of providing control information for UEs in data communication with an eNodeB over a Long Term Evolution (LTE) wireless communication system, the method comprising:

encoding at least one Enhanced-Physical Downlink Control Channel (E-PDCCH) comprising control information for configuring the UEs to communicate data with the eNodeB over the LTE wireless communication system;

mapping the at least one E-PDCCH on at least one allocated pair of Physical Resource Blocks (PRBs) according to an Enhanced-Control Channel Element (E-CCE) structure including a variable number of Resource Element Groups (REGs);

varying the number of REGs in an E-CCE structure to optimise the channel capacity utilisation for the E-PDCCH mapping; and

communicating the at least one E-PDCCH mapped onto the at least one allocated pair of PRBs to the UEs so that the UEs can be configured to communicate said data over the LTE wireless communication system based on the control information.

In one or more embodiments, each E-CCE structure has a size of 3, 4, 5, 6, 9, 10, 11, 12, 14 or 16 REGs or equivalently 12, 16, 20, 24, 36, 40, 44, 48, 56 or 64 Resource Elements (REs).

In one or more embodiments, the E-CCE structure size can vary on a pair of PRBs or group of pairs of PRBs within a sub-frame.

When implemented at an eNodeB, the size of the E-CCE structure may be determined at the eNodeB by:

(1) calculating the number of REs available for E-PDCCH or multiplexed E-PDCCHs mapping on a PRB pair or multiple PRB pairs intended for E-PDCCH(s);

(2) for each E-CCE structure size, calculating the number of remainder REs of the calculated number of REs available for E-PDCCH or multiplexed E-PDCCHs mapping in the step (1), divided by the E-CCE structure size in numbers of REs;

(3) selecting the E-CCE structure size that gives the smallest number of remainder REs in step (2); and

(4) if there are more than 1 E-CCE structure sizes giving the smallest number of remainder REs, then:
a. for each E-CCE structure size giving the smallest number of remainder REs, determining the maximum possible aggregation level from nominated aggregation levels of 1, 2, 4 and 8,
b. for each E-CCE structure size, calculating the remainder of the calculated number of REs available for E-PDCCH or multiplexed E-PDCCHs mapping in the step (1), divided by the maximum possible aggregation level in step (4) a. in number of REs,
c. selecting the E-CCE structure size with the smallest remainder,

(5) or if not, then using the E-CCE structure size selected in step (3).

When implemented at a UE, the size of the E-CCE structure may be determined at the UE by:

(1) calculating the number of REs available for E-PDCCH or multiplexed E-PDCCHs mapping in allocated PRB pair or multiple PRB pairs;

(2) for each E-CCE structure size, calculating the number of remainder REs of the calculated number of REs available for E-PDCCH or multiplexed E-PDCCHs mapping in the step (1), divided by the E-CCE structure size in numbers of REs;

(3) selecting the E-CCE structure size that gives the smallest number of remainder REs in step (2); and

(4) if there are more than 1 E-CCE structure sizes giving the smallest number of remainder REs, then:
a. for each E-CCE structure size giving the smallest number of remainder REs, determining the maximum possible aggregation level from nominated aggregation levels of 1, 2, 4 and 8,
b. for each E-CCE structure size, calculating the remainder of the calculated number of REs available for E-PDCCH or multiplexed E-PDCCHs mapping in the step (1), divided by the maximum possible aggregation level in step (4) a. in number of REs,
c. selecting the E-CCE structure size with the smallest remainder,

(5) or if not, then using the E-CCE structure size selected in step (1).

Another aspect of the invention provides a UE in data communication with an eNodeB over a Long Temi Evolution (LTE) wireless communication system, the UE comprising:

a controller configured to:
receive at least one Enhanced-Physical Downlink Control Channel (E-PDCCH) comprising control information for configuring the UE to communicate data with the eNodeB over the LTE wireless communication system, the at least one E-PDCCH being mapped on at least one allocated pair of Physical Resource Blocks (PRBs) according to an Enhanced-Control Channel Element (E-CCE) structure including a variable number of Resource Element Groups (REGs);
vary the number of REGs in an E-CCE structure to optimise the channel capacity utilisation for the E-PDCCH mapping; and
configure the UE for communicating data with the eNodeB over the LTE wireless communication system based on the control information.

Yet another aspect of the invention provides an eNodeB in data communication with UEs over a Long Term Evolution (LTE) wireless communication system, the eNodeB comprising:

a controller configured to:
transmit at least one Enhanced-Physical Downlink Control Channel (E-PDCCH) comprising control information for configuring the UEs to communicate data with the eNodeB over the LTE wireless communication system, the at least one E-PDCCH being mapped on at least one allocated pair of Physical Resource Blocks (PRBs) according to an Enhanced-Control Channel Element (E-CCE) structure including a variable number of Resource Element Groups (REGs);
vary the number of REGs in an E-CCE structure to optimise the channel capacity utilisation for the E-PDCCH mapping; and
configure the eNodeB for communicating data with the UEs over the LTE wireless communication system based on the control information.

Futher aspect of the invention provides a method of providing control information for user equipments (UEs) in communication with a base station over a wireless communication system. This method includes: mapping at least one enhanced-physical downlink control channel (E-PDCCH) on at least one allocated pair of physical resource blocks (PRBs) according to an enhanced-control channel element (ECCE) structure including a variable number of resource element groups (REGs); and varying the number of REGs in an E-CCE structure.

This method may further includes: encoding the at least one EPDCCH comprising control information for configuring the UEs to communicate with the base station over the wireless communication system; and communicating the at least one E-PDCCH mapped onto the at least one allocated pair of PRBs to the UEs so that the UEs can be configured to communicate over the wireless communication system based on the control information.

In this method, each E-CCE structure may have a size of 3, 4, 5, 6, 9, 10, 11, 12, 14 or 16 REGs.

In this method, each E-CCE structure may have a size of 12, 16, 20, 24, 36, 40, 44, 48, 56 or 64 resource elements (REs).

In this method, the number of REGs may vary from sub-frame to sub-frame.

In this method, the number of REGs may vary within a subframe.

When implemented at a base station, the size of the E-CCE structure may be determined at the base station by:

(1) calculating the number of REs available for E-PDCCH or multiplexed E-PDCCHs mapping on a PRB pair or multiple PRB pairs intended for E-PDCCH(s);

(2) for each E-CCE structure size, calculating the number of remainder REs of the calculated number of REs available for E-PDCCH or multiplexed E-PDCCHs mapping in the step (1), divided by the E-CCE structure size in numbers of REs;

(3) selecting the E-CCE structure size that gives the smallest number of remainder REs in step (2); and

(4) if there are more than 1 E-CCE structure sizes giving the smallest number of remainder REs, then:
a. for each E-CCE structure size giving the smallest number of remainder REs, determining the maximum possible aggregation level from nominated aggregation levels of 1, 2, 4 and 8,
b. for each E-CCE structure size, calculating the remainder of the calculated number of REs available for E-PDCCH or multiplexed E-PDCCHs mapping in the step (1), divided by the maximum possible aggregation level in step (4) a. in number of REs,
c. selecting the E-CCE structure size with the smallest remainder,

(5) or if not, then using the E-CCE structure size selected in step (3).

When implemented at a UE, the size of the E-CCE structure may be determined at the UE by:

(1) calculating the number of REs available for E-PDCCH or multiplexed E-PDCCHs mapping in allocated PRB pair or multiple PRB pairs;

(2) for each E-CCE structure size, calculating the number of remainder REs of the calculated number of REs available for E-PDCCH or multiplexed E-PDCCHs mapping in the step (1), divided by the E-CCE structure size in numbers of REs;

(3) selecting the E-CCE structure size that gives the smallest number of remainder REs in step (2); and

(4) if there are more than 1 E-CCE structure sizes giving the smallest number of remainder REs, then:
a. for each E-CCE structure size giving the smallest number of remainder REs, determining the maximum possible aggregation level from nominated aggregation levels of 1, 2, 4 and 8,
b. for each E-CCE structure size, calculating the remainder of the calculated number of REs available for E-PDCCH or multiplexed E-PDCCHs mapping in the step (1), divided by the maximum possible aggregation level in step (4) a. in number of REs,
c. selecting the E-CCE structure size with the smallest remainder,

(5) or if not, then using the E-CCE structure size selected in step (1).

Another aspect of the invention provides a base station in communication with a user equipment (UE) over a wireless communication system, this base station includes: a mapping unit to map at least one enhanced-physical downlink control channel (E-PDCCH) on at least one allocated pair of physical resource blocks (PRBs) according to an enhanced-control channel element (E-CCE) structure including a variable number of resource element groups (REGs). The base station varies the number of REGs in an E-CCE structure.

This base station may, further include: a transmitting unit to transmit the at least one EPDCCH comprising control information. In this case, the UE is configured for communicating with the base station over the wireless communication system based on the control information.

Yet another aspect of the invention provides a user equipment (UE) in communication with a base station over a wireless communication system. This UE includes: a controller configured to: receive at least one enhanced-physical downlink control channel (EPDCCH) comprising control information for configuring the UEs to communicate with the base station over the wireless communication system, the at least one E-PDCCH being mapped on at least one allocated pair of physical resource blocks (PRBs) according to an enhanced-control channel element (E-CCE) structure including a variable number of resource element groups (REGs). The number of REGs in an E-CCE structure is varied by the base station.

Yet another aspect of the invention provides a method implemented in a base station. This method includes: mapping at least one enhanced-physical downlink control channel (E-PDCCH) on at least one allocated pair of physical resource blocks (PRBs) according to an enhanced-control channel element (ECCE) structure including a variable number of resource element groups (REGs); and varying the number of REGs in an E-CCE structure.

This method may, further include: encoding the at least one EPDCCH comprising control information for configuring the UEs to communicate with the base station over the wireless communication system; and communicating the at least one E-PDCCH mapped onto the at least one allocated pair of PRBs to the UEs so that the UEs can be configured to communicate over the wireless communication system based on the control information.

Yet another aspect of the invention provides a method implemented in a user equipment (UE). This method includes: receiving at least one enhanced-physical downlink control channel (EPDCCH) comprising control information for configuring the UEs to communicate with the base station over the wireless communication system, the at least one E-PDCCH being mapped on at least one allocated pair of physical resource blocks (PRBs) according to an enhanced-control channel element (E-CCE) structure including a variable number of resource element groups (REGs). The number of REGs in an E-CCE structure is varied by the base station.

### Advantageous Effects of Invention

According to the present invention, it is possible to at least optimise the use of control channel resources to improve system capabilities of LTE wireless communication systems.

### BRIEF DESCRIPTION OF DRAWINGS

FIG. 1 is a schematic illustration of a Long Term Evolution (LTE) wireless communication system according to an embodiment of the present invention.

FIG. 2 is a flow chart illustrating encoding E-PDCCH according to an embodiment of the present invention.

FIG. 3 is a graphical representation of an E-CCE of size 36 REs mapping on an allocated PRB pair.

FIG. 4 is a graphical representation of an E-CCE of size 12 REs mapping on an allocated PRB pair.

FIG. 5 is a graphical representation of an E-CCE aggregation for E-CCE size of 12 REs.

FIG. 6 is a graphical representation of an E-CCE of size 20 REs mapping on an allocated PRB pair.

FIG. 7 is a graphical representation of an E-CCE aggregation for E-CCE size of 20 REs.

FIG. 8 is a graphical representation of different E-PDCCH configurations on the same subframe which requires different E-CCE sizes.

FIG. 9 is a flow chart showing steps involved in implementing the calculation of an optimized E-CCE size at an eNodeB.

FIG. 10 is a flow chart showing steps involved in implementing the calculation of an optimized E-CCE size at a UE.

FIG. 11 is a graphical representation of a first example of spatial multiplexing of different composite control information with the same modulation schemes.

FIG. 12 is a graphical representation of a second example of spatial multiplexing of different composite control information with the different modulation schemes.

### DESCRIPTION OF EMBODIMENTS

Embodiments of the present invention will now be described, by way of example only, with reference to the accompanying drawings.

In the current legacy PDCCH design, the mapping of PDCCHs to resource elements is subject to a structure of so called Control-Channel Elements (CCEs), which is a set of 36 useful resources elements that is in turn grouped into 9 resource-element groups (REG) with each REG consisting of 4 RE(s). The number of CCE(s)—namely one, two, four, or eight—required for a certain PDCCH depends on the payload size of the control information (DCI payload) and the channel-coding rate. This is used to realised link adaptation for the PDCCH. If the channel conditions for the terminal to which the PDCCH is intended are disadvantageous, a larger number of CCEs needs to be used compared to the case of advantageous channel conditions. The number of CCEs used for a PDCCH is also referred to as the aggregation level.

For the legacy PDCCH, the number of CCEs available for PDCCHs depends on the size of the control region, the cell bandwidth, the number of downlink antenna ports, and the amount of resources occupied by PHICH. The sizes of the control region can vary dynamically from sub-frame to sub-frame, whereas other quantities are semi-statically configured.

According to the working assumption and agreement achieved for the E-PDCCH (Enhanced-PDCCH), the number of useful RE(s) available for E-PDCCH(s) depends on the size of the control region, the number of allocated PRB pair(s), location of PRB pair(s) (i.e. central 6 or 7 PRBs or other), sub-frame number (i.e. sub-frame #0, 5 or special sub-frame in case of type 2 sub-frame or other sub-frames), the number of CRS configuration, UE specific RS configuration, CSI-RS configuration, and sub-frame's type (i.e. normal CP or extended CP). The size of control region can vary dynamically from sub-frame to sub-frame, whereas other quantities are semi-statically configured but can also affect the number useful RE(s) available for E-PDCCH(s) mapping sub-frame by sub-frame due to the CSI-RS appearing periodically, REs reserved for PBCH, PSS, SSS, PRS and/or special sub-frame in case of type-2 frame structure. This leads to the ineffective usage of the available channel resources if the same CCE size (i.e. 9 REGs) as the legacy PDCCH is used.

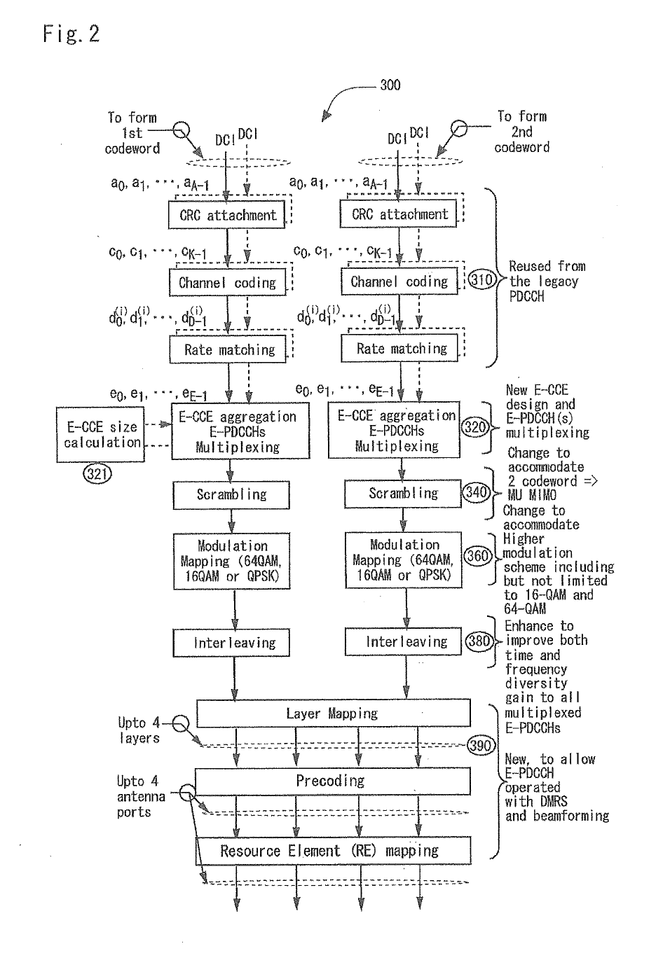

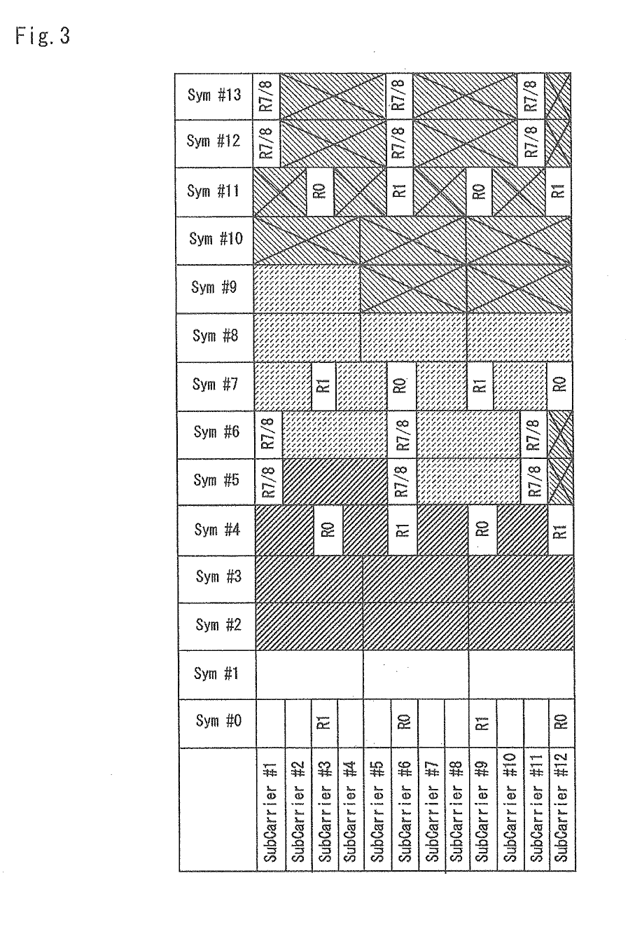

In the simplified example shown in FIG. 3, the used RE(s) are not actually located at the end of sub-frame but are distributed around the allocated PBRs pair after the interleaving function 380 of E-PDCCH coding structure shown in FIG. 2, in the case of:

1. Normal CP sub-frame

2. Control region size is 2 OFDM symbols,

3. 1 Pair of PRBs is allocate for a E-PDCCH within the central 72 sub carrier

4. Sub-frame number is not 0 or 5 or special sub-frame in case of type-2 frame structure.

5. 2 CRS antenna ports,

6. 2 DMRS antenna ports,

7. 2 CSI-RS antenna ports,

8. On sub-frame without CSI-RS.

If the same design as the legacy PDCCH is applied with CCE size of 9 REG(s) (or 36 REs) and aggregation level of 2, there are 12 REGs (or 48 REs) left unused which can possibly be used for E-PDCCH REs additional mapping to increase coding gain hence to improve the E-PDCCH demodulation performance. These unused RE(s) occupy 40% of overall channel capacity available for E-PDCCH mapping. In this case, with the assumption that the current ambiguous sizes of information bit of 12, 14, or 16 is used, the maximum aggregation level is 2 and aggregation level of 1 is not applicable for QPSK modulated E-PDCCH unless coding rate higher than ⅓ is used. This shall limit the link adaptation on the transmitted E-PDCCH that is only 1 coding rate can be used to enable to aggregation level of 1.

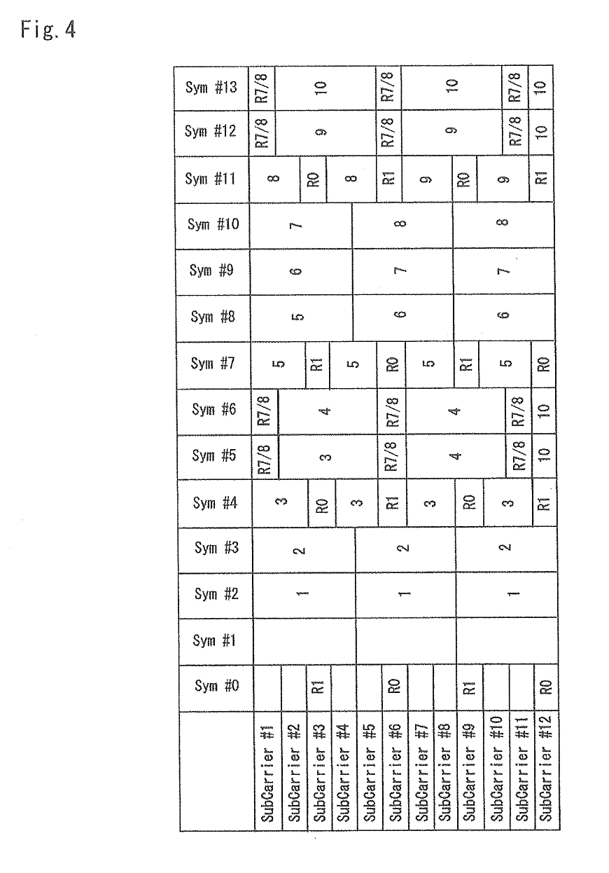

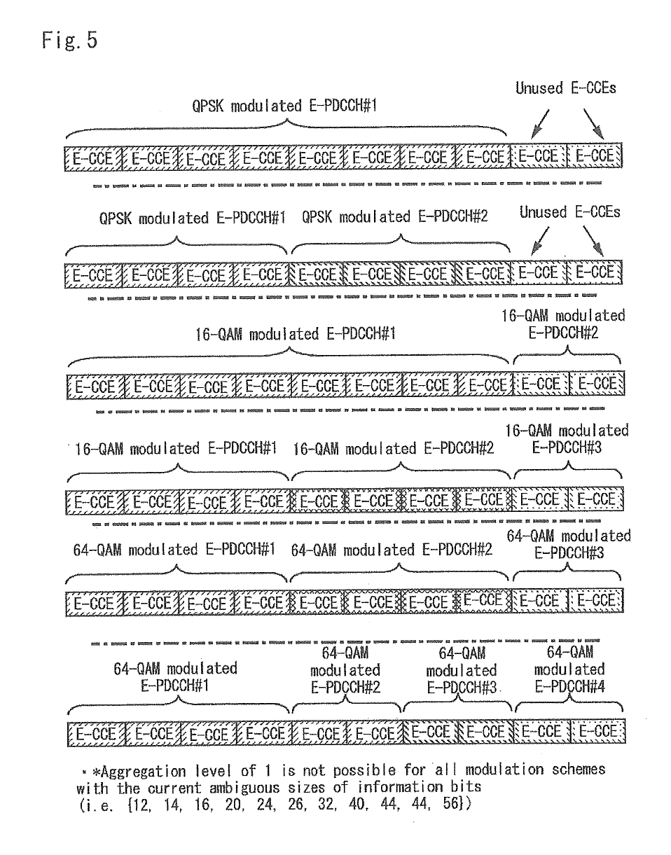

In reference to FIG. 4, and once again noting that this figure is simplified only for illustration purpose as the used RE(s) are not actually located in logical order but being distributed around the allocated PRB pair after the interleaving function 380 of FIG. 2, instead of using CCE size of 9 REG(s) (or 36 REs), the E-CCE size of 3 REG(s) (or 12 REs) is utilised. There will be 10 CCEs can be fitted into the allocated pair of PRB. If aggregation level of 8 is used. There are 6 REGs (i.e. 24 REs) left unused. That is 20% overall channel capacity available for E-PDCCH mapping. Furthermore, the maximum aggregation level of 8 with possible aggregation levels of 4 and 8 in case of E-PDCCH(s) is QPSK modulated with the assumption that the current ambiguous sizes of information bit of 12, 14, or 16 is used as being illustrated in the lower parts of FIG. 5. That provides better link adaptation in term of different aggregation level. When considering higher modulation schemes such as 16-QAM or 64-QAM, multiple E-PDCCH(s) with the same modulation level can be multiplexed and utilised all available REs with possible aggregation levels of {2, 4, 8}. This illustrated in FIG. 5 for 16-QAM and 64-QAM modulated E-PDCCH(s).

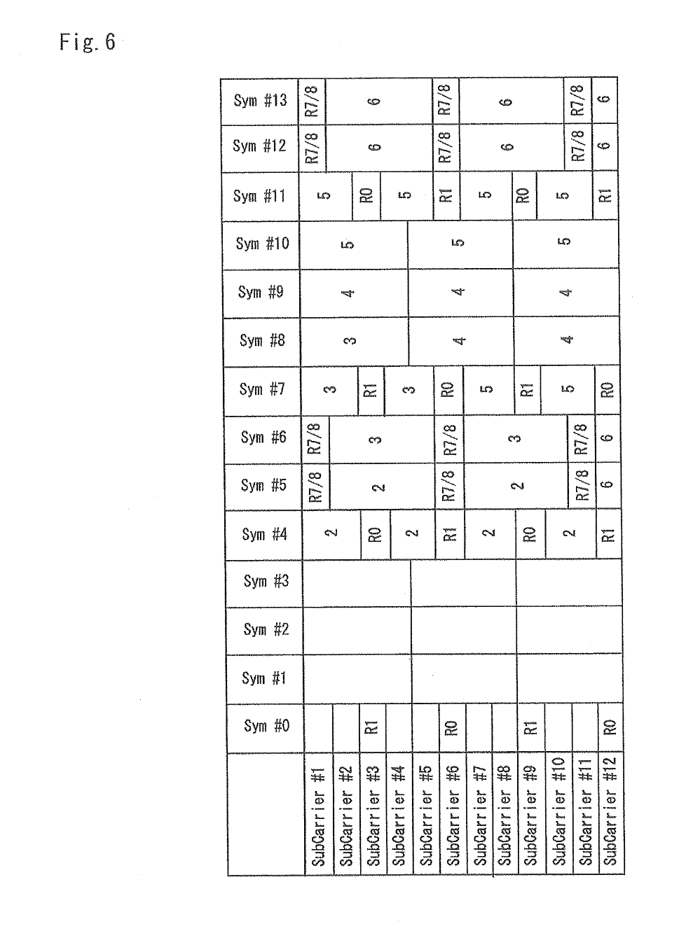

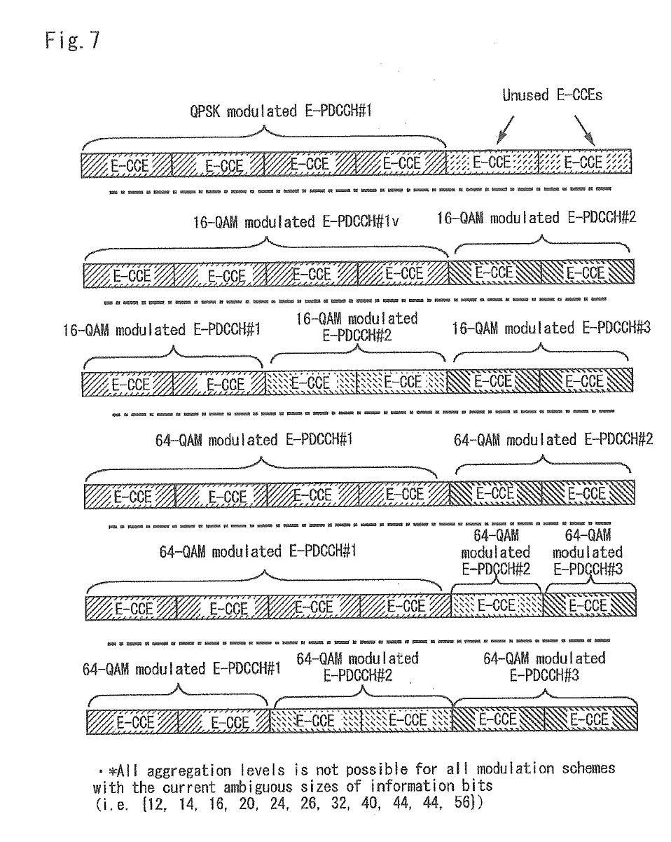

In reference to FIG. 6, and once again noting that this figure is simplified only for illustration purpose as the used RE(s) are not actually located logical order but being distributed around the allocated PRB pair after the interleaving function 380 of FIG. 2, instead of using CCE size of 9 REG(s) (i.e. 36 REs), the E-CCE size of 5 REG(s) (i.e. 20 REs) is utilised. 6 CCEs can be fitted into the allocated pair of PRB if an aggregation level of 4 is used. There are 10 REGs (or 40 REs) left unused. That is 33% overall channel capacity available for E-PDCCH mapping. Furthermore, the maximum aggregation level of 4 with no other possible aggregation levels in case of E-PDCCH(s) is QPSK modulated as being illustrated in the upper part of FIG. 7. When considering higher modulation schemes such as 16-QAM or 64-QAM, multiple E-PDCCH(s) with the same modulation level can be multiplexed and utilised all available REs with possible aggregation levels of {1, 2, 4}. This is illustrated in the lower parts of FIG. 7 for 16-QAM and 64-QAM modulated E-PDCCH(s).

The above examples demonstrate the need for different CCE size design for E-PDCCH in order to utilise the channel capacity allocated to E-PDCCH efficiently as well as allow link adaptation being realised effectively.

According to one or more embodiments, the present invention proposes a set of different E-CCE sizes to be used for E-PDCCH, as well as a method for calculating and selecting of appropriate E-CCE sizes on a sub-frame basis for implementation at the eNodeB and UEs so that there is no need to use signalling to inform a UE of the configured E-CCE size used at its eNodeB.

According to one or more embodiments, the set of E-CCE sizes nominated for E-PDCCH is but not limited to {3, 4, 5, 6, 9, 10, 11, 12, 14, 16} REGs or being equivalent to {12, 16, 20, 24, 36, 40, 44, 48, 56, 64} REs.

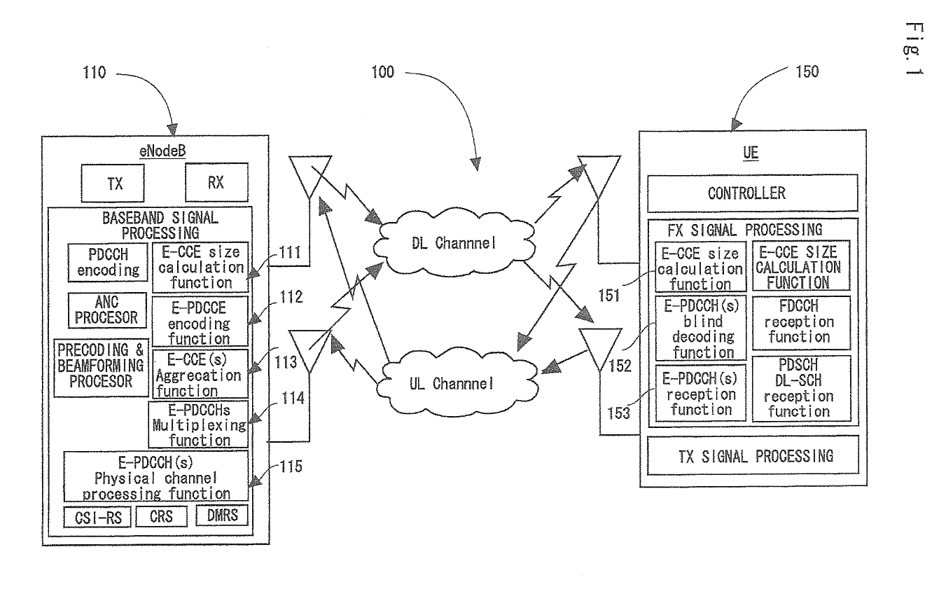

An LTE wireless communication system 100 supporting E-PDCCH with variable E-CCE size is illustrated in FIG. 1.

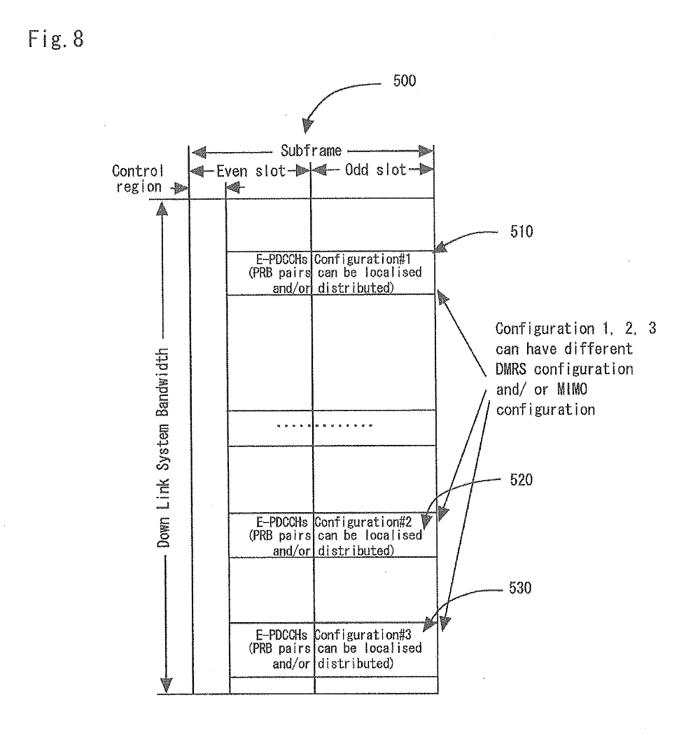

The wireless system 100 comprises an eNodeB 110 for encoding control information and transmission of E-PDCCH(s) to an intended UE 150 via wireless channel using
a. implemented E-PDCCH encoding function 112 to encode the transmitted control information,
b. E-CCE size calculation function 111 to derive optimum E-CCE size for link adaptation,
c. implemented E-CCE(s) aggregation function 113 and E-PDCCHs multiplexing function 114 to form composite control information, and
d. Implemented E-PDCCH(s) physical channel processing function 115 to perform layer mapping, pre-coding and E-PDCCH(s) RE mapping on allocated PRB pairs for transmitting E-PDCCHs. Furthermore, the eNodeB can map E-PDCCH(s) with different configurations targeting different group of UEs or group of E-PDCCHs to maximise channel condition, link adaptation, and beamforming as well as performance target as being illustrated in FIG. 8.

The detailed E-PDCCH channel coding and physical channel coding (300) is further illustrated in FIG. 2.

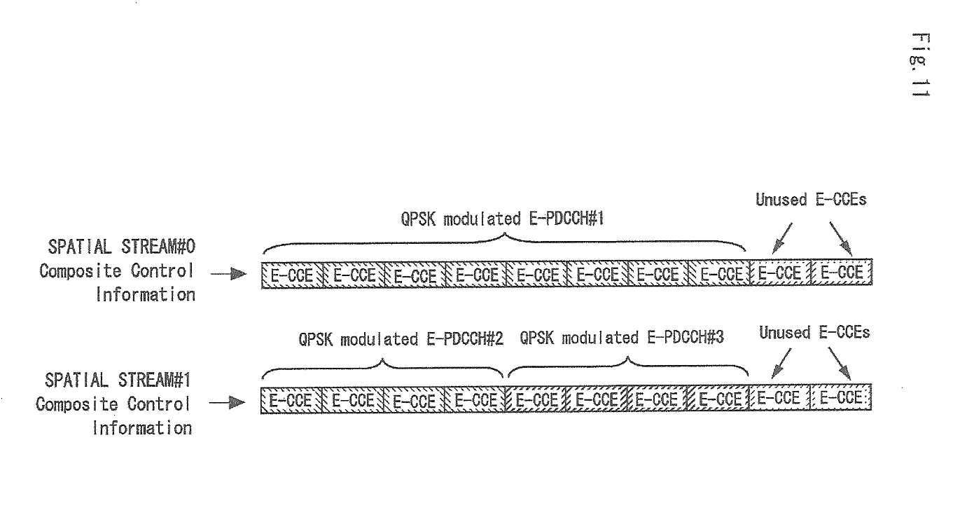

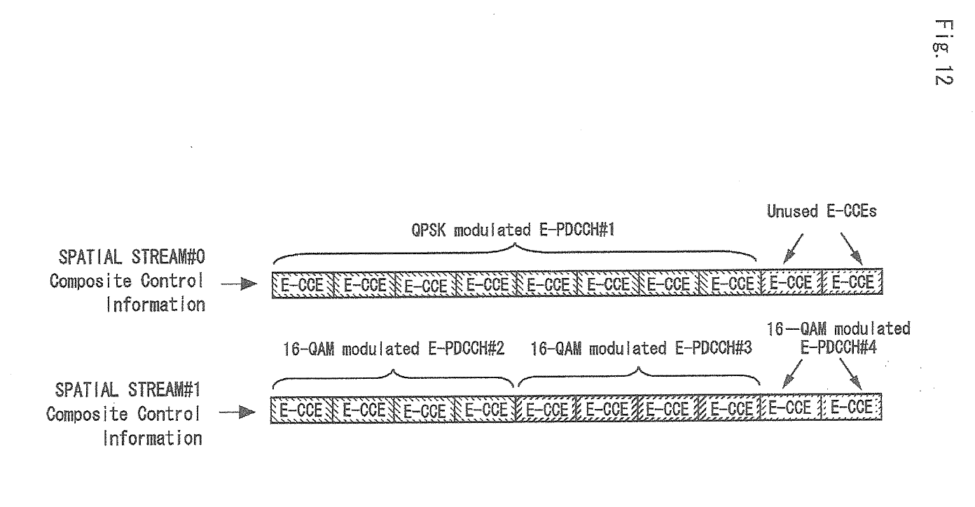

Additionally, the exemplary eNodeB implemented E-PDCCH(s) physical channel processing function 115 has spatial multiplexing of composite control information stream with same or different modulation schemes for multi-layers transmission and precoding as being illustrated in FIGS. 11 and 12 respectively.

The wireless system 100 further comprises a UE 150 for performing the reception, detection and decoding of its indented E-PDCCH(s) using E-PDCCH(s) reception function 153, E-CCE size calculation function 151, and E-PDCCH(s) blind decoding function 152.

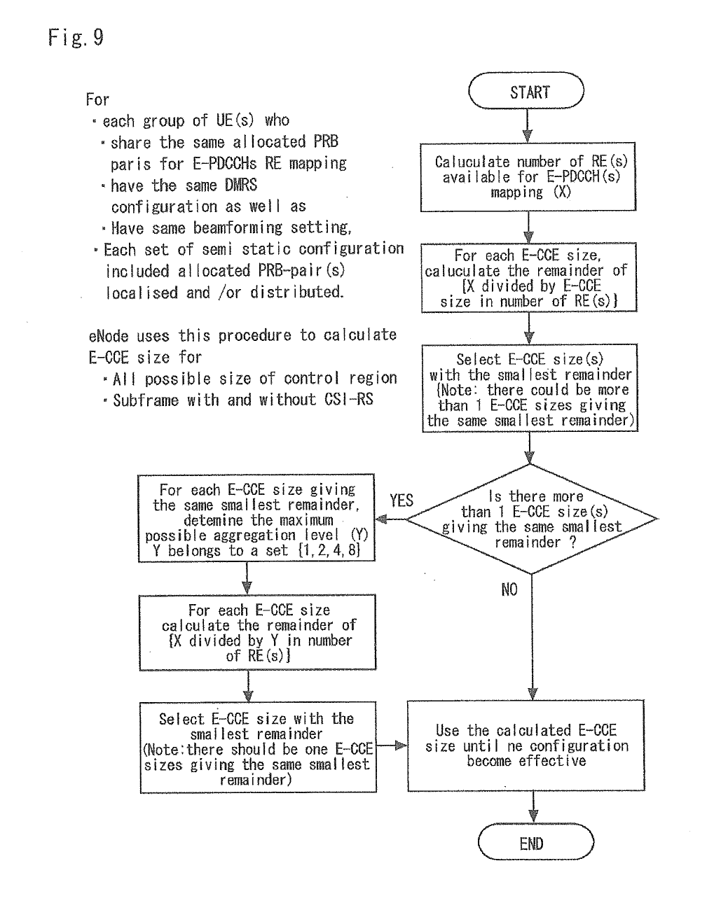

The eNodeB implemented E-CCE size calculation function is further described in the following steps with the summarised procedure specified in FIG. 9.

In a wireless system, UE(s) belonging to an eNodeB are geometrically distributed and therefore different configurations for a UE or group of UE(s) can improve the E-PDCCH(s) demodulation performance. This also requires different E-CCE sizes to be used for each UE or group of UE(s) which shares the same allocated PRB pairs for E-PDCCH(s) RE(s) mapping and/or beam forming configuration. For each group of UEs who share the same allocated PRB pairs for E-PDCCHs RE mapping, have the same DMRS configuration, and have same beam forming configuration setting, with each semi-static configuration the eNodeB calculates E-CCE sizes for all possible size of control region and sub-frame with and without CSI-RS using the following steps:
1. Calculate number of RE(s) available for E-PDCCH(s) mapping,
2. For each E-CCE size, calculate the remainder RE(s) of the Calculated number of RE(s) available for E-PDCCH(s) mapping in (1) divided by E-CCE size in number of RE(s),
3. Select E-CCE size(s) that give the smallest remainder in (2),
4. If there are more than 1 E-CCE sizes giving the same smallest remainder, then
   a. For each E-CCE size giving the same smallest remainder, Determine the maximum possible aggregation level, and the nominate aggregation level is {1, 2, 4, 8},
   b. For each E-CCE size calculate the remainder of the Calculated number of RE(s) available for E-PDCCH(s) mapping in (1) divided by maximum possible aggregation level in (a) in number of RE(s),
   c. Select E-CCE size with the smallest remainder.
5. Else, use the E-CCE size selected in (3)

For every sub-frame the eNodeB uses the calculated E-CCE size corresponding to the dynamically configured control region size with or without CSI-RS for the E-PDCCH encoding, E-CCEs aggregation and E-PDCCH(s) multiplexing. These eNodeB calculated E-CCE size(s) will be valid until the set of semi-static parameters being reconfigured and activated or number of allocated PRB-pairs has been changed and become effective.

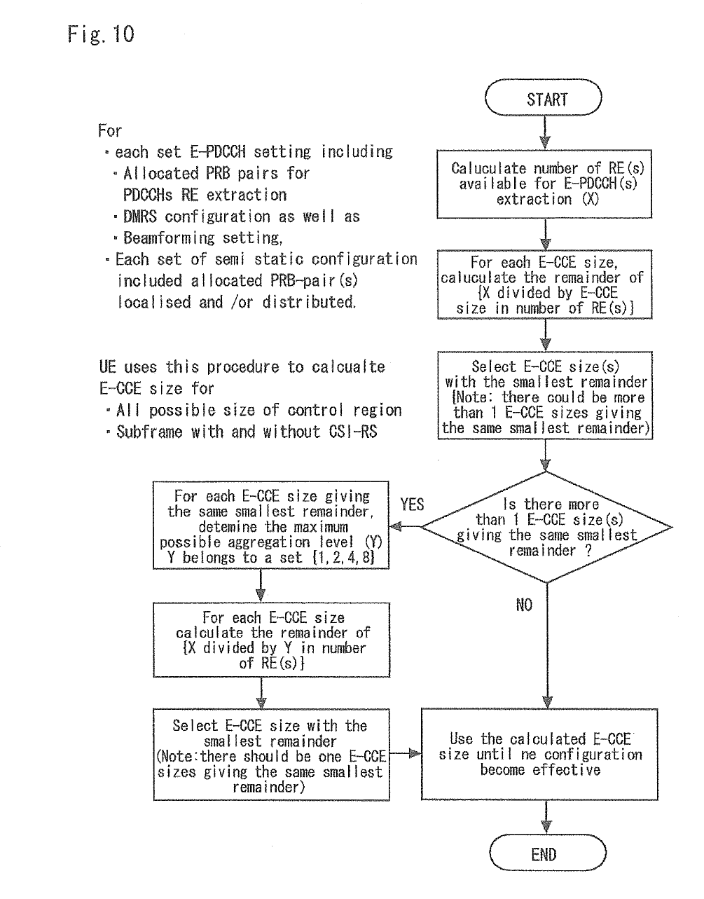

To enable UE(s) to apply the same E-CCE sizes that have been calculated and used by eNodeB without signalling, the UE(s) implements the procedure for calculating E-CCE sizes described in the following steps with the summarised procedure specified in FIG. 10.

In a wireless system such as system 100, an eNodeB can configure a UE to monitor different set of allocated PRB pairs for different E-PDCCH(s) configurations as being illustrated in FIG. 8. This also requires different E-CCE sizes to be used for each E-PDCCH configurations that a UE is configured to monitor. For each E-PDCCH configurations that a UE is configured to monitor the UE calculates E-CCE sizes for all possible sizes of control region and sub-frame with and without CSI-RS, using the following steps:
1. Calculate number of RE(s) available for E-PDCCH(s) mapping,
2. For each E-CCE size, calculate the remainder RE(s) of the Calculated number of RE(s) available for E-PDCCH(s) mapping in (1) divided by E-CCE size in number of RE(s),
3. Select E-CCE size(s) that give the smallest remainder in (2),
4. If there are more than 1 E-CCE sizes giving the same smallest remainder, then
   a. For each E-CCE size giving the same smallest remainder, Determine the maximum possible aggregation level, and the nominate aggregation level is {1, 2, 4, 8},
   b. For each E-CCE size calculate the remainder of the Calculated number of RE(s) available for E-PDCCH(s) mapping in (1) divided by maximum possible aggregation level in (a) in number of RE(s),
   c. Select E-CCE size with the smallest remainder.
5. Else, use the E-CCE size selected in (3)

For every sub-frame, the UE will use the calculated E-CCE size corresponding to the dynamically detected control region size and with or without CSI-RS for the E-PDCCH(s) reception and E-PDCCH(s) blind decoding for its intended control information. These UE's calculated E-CCE size(s) will be valid until the set of semi-static parameters being reconfigured and activated or number of allocated PRB-pairs has been changed and become effective.

From the foregoing, it will be appreciated that the various described embodiments of the invention provide the following non-exhaustive list of advantages:
1. Various E-PDCCH E-CCE sizes can be selected and configured by eNodeB to effectively utilise the Resource Element(s) (REs) available for mapping the E-PDCCH(s) in a pair of PRB(s) or multiple pairs of PRB(s).
2. Procedures are implemented by the eNodeB for calculating optimised E-CCE sizes and applying the calculated E-CCE on subframe basis without notifying UE.
3. Procedures are implemented by the UE for calculating optimised E-CCE sizes used by eNodeB and applying the correct E-CCE used by eNodeB on sub-frame by sub-frame basis and E-PDCCH configuration by E-PDCCH configuration basis without signalling.
4. E-PDCCH(s) are mapped with different configurations on the same channel BW to obtain optimum link adaptation and channel conditions and maintain optimised E-PDCCHs channel allocation by using different E-CCE sizes on different E-PDCCH configuration.
5. Composite control infatuation streams are multiplexed with different E-CCE aggregation and modulation schemes

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by the skilled person.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

Throughout the description and claims of this specification, the word “comprise” and variations of the word, such as “comprising” and “comprises”, is not intended to exclude other additives, components, integers or steps.

This application is based upon and claims the benefit of priority from Australian Provisional Patent Application No. 2012901017, filed on Mar. 14, 2012, the disclosure of which is incorporated herein in its entirety by reference.

### INDUSTRIAL APPLICABILITY

The present invention can be applied to a method of providing control information for User Equipment (UEs) in data communication with an eNodeB over a Long Term Evolution (LTE) wireless communication system.

### REFERENCE SIGNS LIST

100 LTE WIRELESS COMMUNICATION SYSTEM
110 eNodeB
111 E-CCE SIZE CALCULATION FUNCTION
112 E-PDCCH ENCODING FUNCTION
113 E-CCE(s) AGGREGATION FUNCTION
114 E-PDCCHs MULTIPLEXING FUNCTION
115 E-PDCCH(s) PHYSICAL CHANNEL PROCESSING FUNCTION
150 USER EQUIPMENT (UE)
151 E-CCE SIZE CALCULATION FUNCTION
152 E-PDCCH(s) BLIND DECODING FUNCTION
153 E-PDCCH(s) RECEPTION FUNCTION

1. A method of providing control information for user equipments (UEs) in communication with a base station over a wireless communication system, the method comprising:
mapping at least one enhanced-physical downlink control channel (E-PDCCH) on at least one allocated pair of physical resource blocks (PRBs) according to an enhanced-control channel element (ECCE) structure including a variable number of resource element groups (REGs); and
varying the number of REGs in an E-CCE structure.

2. The method according to claim 1, further comprising:
encoding the at least one EPDCCH comprising control information for configuring the UEs to communicate with the base station over the wireless communication system; and
communicating the at least one E-PDCCH mapped onto the at least one allocated pair of PRBs to the UEs so that the UEs can be configured to communicate over the wireless communication system based on the control information.

3. The method according to claim 1 or 2, wherein each E-CCE structure has a size of 3, 4, 5, 6, 9, 10, 11, 12, 14 or 16 REGs.

4. The method according to claim 1 or 2, wherein each E-CCE structure has a size of 12, 16, 20, 24, 36, 40, 44, 48, 56 or 64 resource elements (REs).

5. The method according to any one of claims 1 to 4, wherein the number of REGs varies from sub-frame to sub-frame.

6. The method according to any one of claims 1 to 4, wherein the number of REGs varies within a sub-frame.

7. The method according to any one of claims 1 to 4 when implemented at a base station, wherein the size of the E-CCE structure is determined at the base station by:
(1) calculating the number of REs available for E-PDCCH or multiplexed EPDCCHs mapping on a PRB pair or multiple PRB pairs intended for E-PDCCH(s);
(2) for each E-CCE structure size, calculating the number of remainder REs of the calculated number of REs available for E-PDCCH or multiplexed E-PDCCHs mapping in the step (1), divided by the E-CCE structure size in numbers of REs;
(3) selecting the E-CCE structure size that gives the smallest number of remainder REs in step (2); and
(4) if there are more than 1 E-CCE structure sizes giving the smallest number of remainder REs, then:
a. for each E-CCE structure size giving the smallest number of remainder REs, determining the maximum possible aggregation level from nominated aggregation levels of 1, 2, 4 and 8,
b. for each E-CCE structure size, calculating the remainder of the calculated number of REs available for E-PDCCH PDCCH or multiplexed E-PDCCHs mapping in the step (1), divided by the maximum possible aggregation level in step (4) a. in number of REs,
c. selecting the E-CCE structure size with the smallest remainder,
(5) or if not, then using the E-CCE structure size selected in step (3).

8. The method according to any one of claims 1 to 4 when implemented at a UE, wherein the size of the E-CCE structure is determined at the UE by:
(1) calculating the number of REs available for E-PDCCH or multiplexed EPDCCHs mapping in allocated PRB pair or multiple PRB pairs;
(2) for each E-CCE structure size, calculating the number of remainder REs of the calculated number of REs available for E-PDCCH or multiplexed E-PDCCHs mapping in the step (1), divided by the E-CCE structure size in numbers of REs;
(3) selecting the E-CCE structure size that gives the smallest number of remainder REs in step (2); and
(4) if there are more than 1 E-CCE structure sizes giving the smallest number of remainder REs, then:
a. for each E-CCE structure size giving the smallest number of remainder REs, determining the maximum possible aggregation level from nominated aggregation levels of 1, 2, 4 and 8,
b. for each E-CCE structure size, calculating the remainder of the calculated number of REs available for E-PDCCH or multiplexed EPDCCHs mapping in the step (1), divided by the maximum possible aggregation level in step (4) a. in number of REs,
c. selecting the E-CCE structure size with the smallest remainder,
(5) or if not, then using the E-CCE structure size selected in step (1).

9. A base station in communication with a user equipment (UE) over a wireless communication system, the base station comprising:
a mapping unit to map at least one enhanced-physical downlink control channel (E-PDCCH) on at least one allocated pair of physical resource blocks (PRBs) according to an enhanced-control channel element (E-CCE) structure including a variable number of resource element groups (REGs),
wherein the base station varies the number of REGs in an E-CCE structure.

10. The base station according to claim 9, further comprising:
a transmitting unit to transmit the at least one EPDCCH comprising control information,
wherein the UE is configured for communicating with the base station over the wireless communication system based on the control information.

11. A user equipment (UE) in communication with a base station over a wireless communication system, the UE comprising:
a controller configured to:
receive at least one enhanced-physical downlink control channel (EPDCCH) comprising control information for configuring the UEs to communicate with the base station over the wireless communication system, the at least one E-PDCCH being mapped on at least one allocated pair of physical resource blocks (PRBs) according to an enhanced-control channel element (E-CCE) structure including a variable number of resource element groups (REGs),
wherein the number of REGs in an E-CCE structure is varied by the base station.

12. A method implemented in a base station, the method comprising:
mapping at least one enhanced-physical downlink control channel (E-PDCCH) on at least one allocated pair of physical resource blocks (PRBs) according to an enhanced-control channel element (ECCE) structure including a variable number of resource element groups (REGs); and
varying the number of REGs in an E-CCE structure.

13. The method according to claim 12, further comprising:
encoding the at least one EPDCCH comprising control information for configuring the UEs to communicate with the base station over the wireless communication system; and
communicating the at least one E-PDCCH mapped onto the at least one allocated pair of PRBs to the UEs so that the UEs can be configured to communicate over the wireless communication system based on the control information.

14. A method implemented in a user equipment (UE), the method comprising:
receiving at least one enhanced-physical downlink control channel (EPDCCH) comprising control information for configuring the UEs to communicate with the base station over the wireless communication system, the at least one E-PDCCH being mapped on at least one allocated pair of physical resource blocks (PRBs) according to an enhanced-control channel element (E-CCE) structure including a variable number of resource element groups (REGs),
wherein the number of REGs in an E-CCE structure is varied by the base station.
